(19) United States
(12) Patent Application Publication
(10) Pub. No.: US 2006/0261224 A1
(43) Pub. Date: Nov. 23, 2006

(54) Brackets, water gardens, kits, and method incorporating the same

(76) Inventors: Furman O' Dell, Evergreen, CO (US); Lynn Hunter, Parker, CO (US)

Correspondence Address: JACOBSON HOLMAN PLLC, 400 SEVENTH STREET N.W., SUITE 600, WASHINGTON, DC, 20004, US

(21) Appl. No.: 11/415,424

(22) Filed: May 2, 2006

Related U.S. Application Data
(60) Provisional application No. 60/594,733, filed on May 2, 2005.

(51) Int. Cl. F21V 21/00

(52) U.S. Cl. 248/226.11

(57) ABSTRACT

An adjustable bracket for mounting and supporting a water garden accessory on the sidewall of a support structure to create a water garden, as well as a kit and method for creating a water garden using the bracket. The bracket includes a mounting platform and a support arm that is cooperatively adjustable with the platform to accommodate sidewalls of different widths. Elongated apertures in the mounting platform, through which the accessory is secured to the platform, also allow the water garden accessory to be mounted in a wide range of positions for proper balancing on the sidewall.

### RELATED APPLICATIONS

This application is entitled to and hereby claims the priority of co-pending U.S. Provisional application Ser. No. 60/594,733 filed May 2, 2005.

### FIELD OF THE INVENTION

The present invention generally relates to weight bearing structures useful for supporting selected items. More particularly, the present invention relates to brackets useful for outdoor lawn and gardening applications. The brackets of the present invention have particular usefulness for mounting water related accessory items for ground water gardens. The present invention also concerns a kit for the assembly of above-ground water gardens, using the brackets of the present invention. The present invention further concerns a method of mounting water garden accessory items to water garden vessels.

### BACKGROUND OF THE INVENTION

Many people enjoy spending time in their back yards or around the premises of their domicile. As such, many hire landscapers or simply choose to work in their back yards, weeding, planting, and keeping their grounds manicured and pleasant.

Water gardens are becoming a very attractive addition for many backyards and patios and particularly those having water pumps, which power fountains or other water accessory items to provide movement to the water. Water gardens can be elaborate and incorporate waterfalls, lights, rockwork, and even fish. Alternatively, water gardens can be quite simple and include a conventional, submersible water pump connected to simple or decorative nozzles with various aquatic plants.

Whether elaborate or simple, water gardens are easy to take care of in that there is little weeding or water involved, while at the same time, these gardens can produce vibrantly colored and fragrant lilies and other aquatic flowers that are enjoyable. Coupled with the relaxation and comfort many tend to find from the sound of moving water, the water garden industry is increasing in popularity.

Above-ground water gardens that make efficient use of space can be ideal for those with limited space for landscaping. Many kits can be purchased for constructing such above-ground water gardens from whiskey barrels, or other similar vessels. Since whiskey barrels are not waterproof, they are provided with liners, such as pool liners or other plastic or rubber liners. Submersible pumps attached to decorative nozzles or spitters are also associated with these whiskey barrel water gardens. However, due to the limited size of whiskey barrels, it is sometimes difficult, if not impossible, to associate a spitter or other accessory with the garden. Many have opted to span a portion of the barrel with a plank of wood and place their desired items on the wood. However, this compromises the available space and, for some, is unsightly, detracting from the beauty of the garden.

Accordingly, there remains a need to provide alternatives for those who desire to have water gardens for associating those gardens with selected accessory items without detracting from the garden itself, or further making inefficient use of the available space. There is also a need for a new kit that provides such an alternative. The present invention is directed to meeting these needs.

### OBJECTS OF THE INVENTION

An object of the present invention is to provide a device that supports a selected gardening accessory item at a desired location.

Another object of the present invention is to provide a device useful for supporting water accessory items associated with water gardens and that is not highly visible.

A further object of the present invention is to provide a kit that includes items useful for creating water gardens.

Yet another object of the present invention is to provide a simplified construction useful in connection with water garden accessories that is relatively easy to manufacture and relatively inexpensive.

These and other objects of the present invention will become more readily appreciated and understood from a consideration of the following detailed description of the exemplary embodiments of the present invention when taken together with the accompanying drawings.

### BRIEF DESCRIPTION OF THE DRAWINGS

FIG. 1 is a perspective view of a water garden incorporating a bracket and a water garden accessory according to the first embodiment of the present invention.

FIG. 2 is a perspective exploded view of the water garden shown in FIG. 1.

FIG. 3 is an exploded perspective view of a first exemplary embodiment of the bracket according to the present invention.

FIG. 4 is a back perspective view of the mounting platform of the bracket shown in FIG. 3.

FIG. 5 is a perspective view of the support leg of the bracket shown in FIG. 3.

FIG. 6 is a front view in elevation of the assembled mounting platform and support leg shown in FIG. 3.

FIG. 7 is a back view in elevation of the mounting platform and support leg shown in FIG. 3.

FIG. 8 is an exploded side view of the bracket and water garden accessory, shown in the form of a spitter fountain, wherein both the mounting rod and threaded nut are visable.

FIG. 9 is an exploded perspective view of the bracket and water garden accessory.

FIG. 10 is a side view of the bracket and water garden accessory.

FIG. 11 is a front view in elevation of the assembled water garden accessory and bracket.

FIG. 12 is a back view in elevation of the water garden accessory and bracket.

FIG. 13 is a perspective view of the assembled water garden accessory and bracket shown mounted on a sidewall of a water vessel wherein the sidewall and liner appear therewith in partial cross-section.

FIG. 14 is a back view in elevation of the mounted water garden accessory shown in FIG. 13.

FIG. 15(a) is a perspective view of the bracket showing the support leg and mounting post at a first selected location.

FIG. 15(b) is a perspective view of the bracket showing both the support leg and mounting post at a second selected location that is different from that in FIG. 15(a).

FIG. 15(c) is a perspective view of the bracket showing both the support leg and mounting post at a third selected location that is different from both the first and second locations shown in FIGS. 15(a) and 15(b).

FIG. 16 is a perspective view of a bracket according to a second exemplary embodiment according to the present invention.

FIG. 17 is a perspective view of the mounting platform that is part of the bracket shown in FIG. 16.

FIG. 18 is perspective view of the support leg of the bracket shown in FIG. 16.

FIG. 19 is a front view in elevation of the assembled bracket shown in FIG. 16.

FIG. 20 is an exploded perspective view of the bracket shown in connection with the hood that is inserted through the aperture of the mounting platform.

FIG. 21 is a front view in elevation of the bracket shown together with the mounting rod, threaded nut and hose.

FIG. 22 is a right side view in elevation of the bracket shown in FIG. 21.

FIG. 23 is a back view in elevation of the bracket shown in FIG. 21.

### DETAILED DESCRIPTION OF THE PREFERRED EMBODIMENTS

The present invention broadly concerns weight-bearing structures useful for supporting selected items. More particularly, the present invention concerns brackets useful for supporting accessory items associated with above-ground water gardens. The present invention also concerns a water gardening kit that includes, among various items, a bracket to support accessory items, such as a fountain spitter. The present invention further concerns a method of mounting a water garden accessory item to the sidewall of a vessel.

Generally, the bracket according to the present invention includes two components—a mounting platform that is adapted for support on a structure, such as a water garden vessel, to provide a surface upon which selected accessory items may be seated; and a support leg that cooperates with the mounting platform to retain its position relative to the support structure and enable it to bear the weight of the accessory item. The bracket components may be constructed as two individual pieces that, when assembled, form a bracket that straddles the sidewall of a water garden vessel. Preferably, the bracket is of sufficient size to bear the weight of the accessory item, while also being at least partly concealed from view so as not to detract from the aesthetic appearance of the water garden.

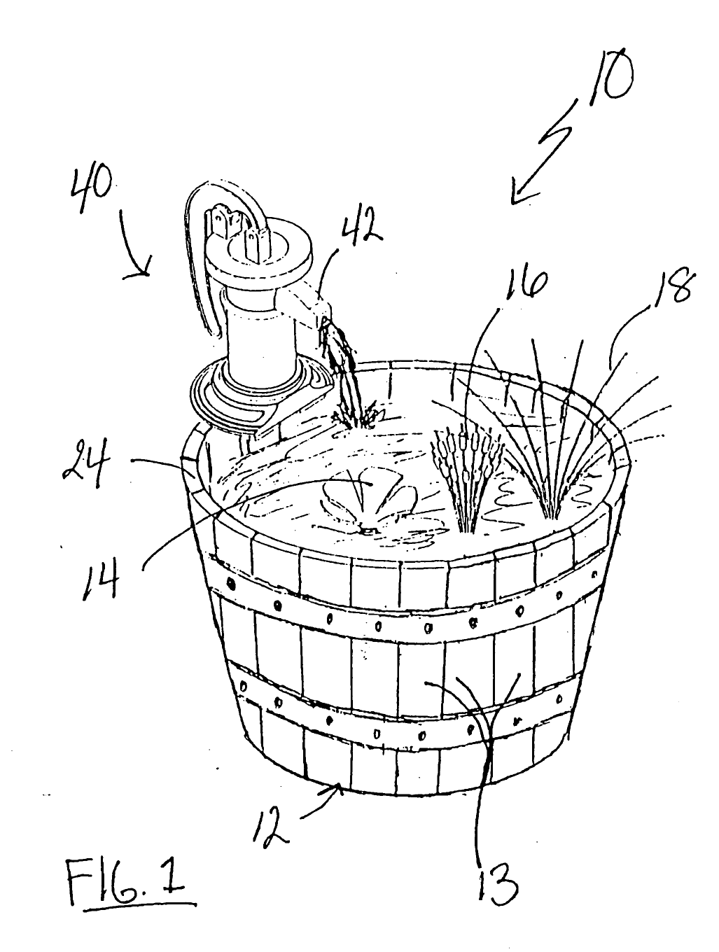

One type of above-ground water garden is shown in FIG. 1. Here, water garden 10 includes vessel 12, in the form of a whiskey barrel, which contains water and aquatic plants such as lily 14 floating on the water surface, cattails 16, and grass 18. The water garden may include real or faux plant life, as desired, and may further include fish or other water gardening accessories such as rocks and decorative pebbles, snails, and the like. As should be appreciated, a whisky barrel, as shown here, is for exemplary purposes only and any suitable vessel, that accommodates the structure of the bracket described below, may be used.

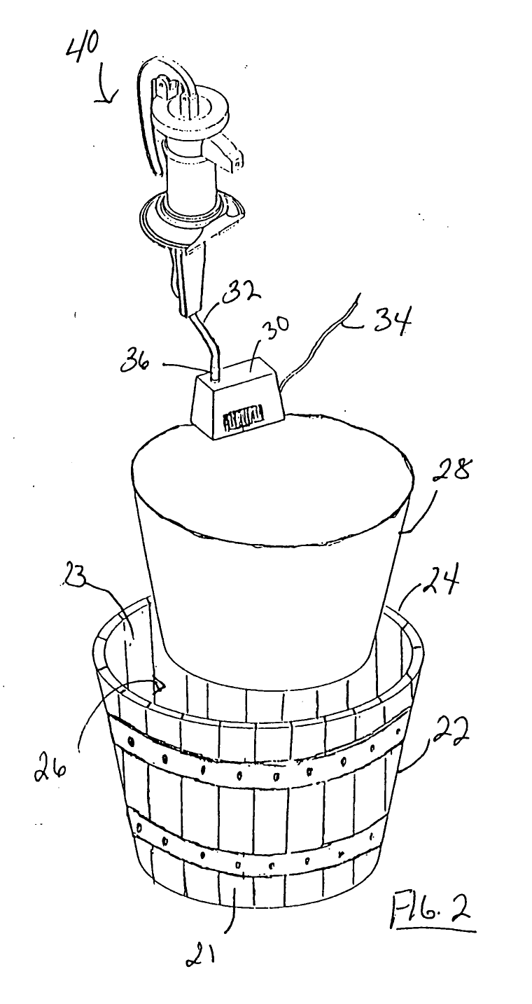

With continued reference to FIG. 1 and with additional reference to FIG. 2, vessel 12 includes a circumferential sidewall 22 formed by a plurality of wooden barrel staves 13 extending upwardly from the bottom wall of the barrel (not shown) to terminate in a continuously extending circumferential top edge 24 and defining a vessel interior 26. Sidewall 22 has an outer surface 21 and an oppositely facing inner surface 23. Waterproof liner 28 is disposed in the interior 26 of vessel 12 thereby allowing vessel 12 to retain the water for the garden. Liner 28 may be any suitable liner, such as a pool or pond liner as known in the art and may be rigid or flexible and of a suitable size to be disposed within the interior of the vessel and line the sidewall thereof. However, should the selected vessel already be waterproof by other means, a liner, such as liner 28, may be unnecessary.

Decorative spitter fountain 40, shown here in the form of an antique water pump, is supported by vessel 12 and located proximate to top edge 24. Spitter fountain 40 is in fluid communication with a submersible recirculating water pump 30, by means of hose 32. One end of hose 32 is fixed within spitter fountain 40, while the opposite end is secured into pump 30 at connector 36. Pump 30 includes electrical cord 34 that can be plugged into an electrical outlet. When activated, pump 30, which is submerged in vessel 12, pumps water from within the vessel and through spitter fountain 40. The water is then dispensed through spout 42, as shown in FIG. 1, and returned back to vessel 12.

The bracket of the present invention is interposed between top edge 24 of the vessel sidewall 22 and spitter fountain 40. More particularly, the bracket is mounted to the sidewall and straddles the top edge 24, supporting the spitter fountain thereabove. However, before discussing how the spitter fountain is mounted onto the bracket, it is perhaps first helpful to discuss the various features of the bracket.

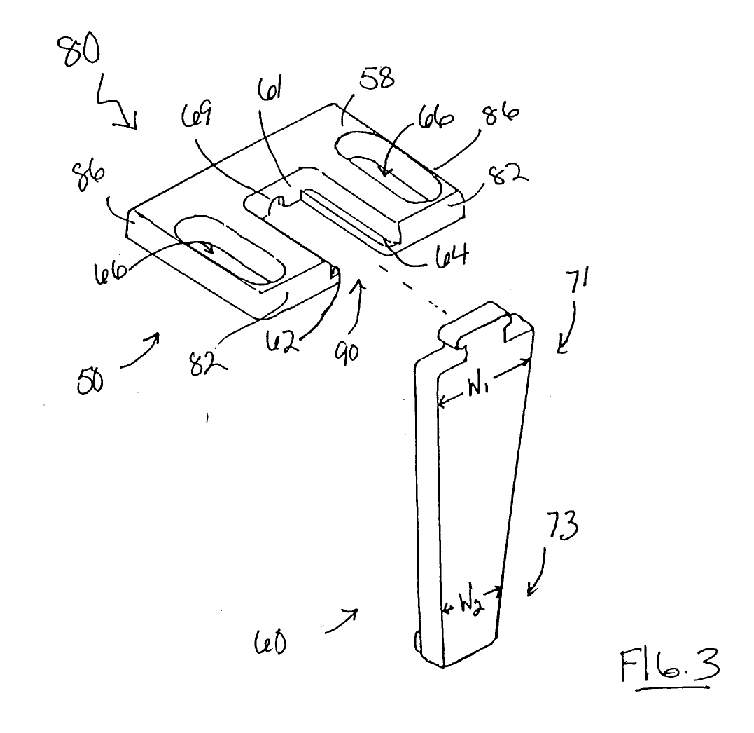

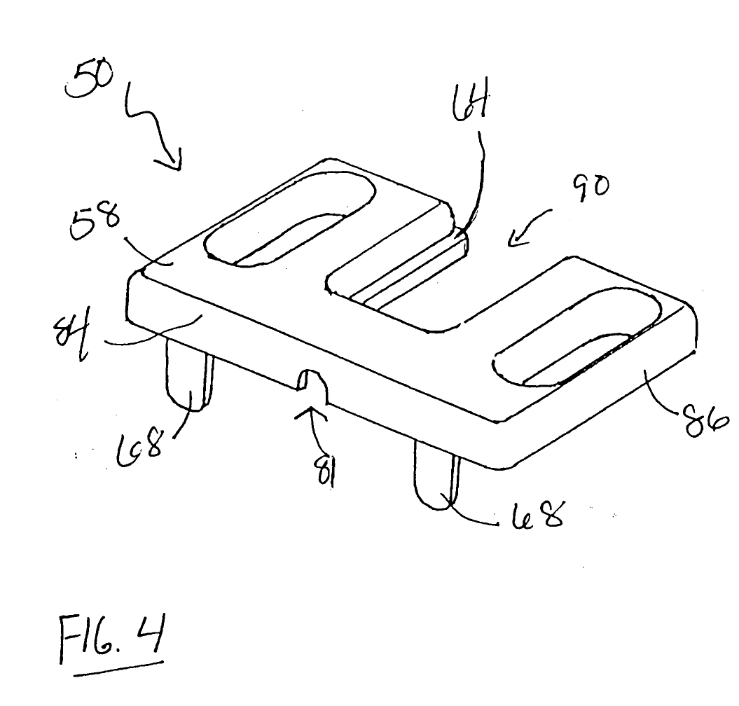

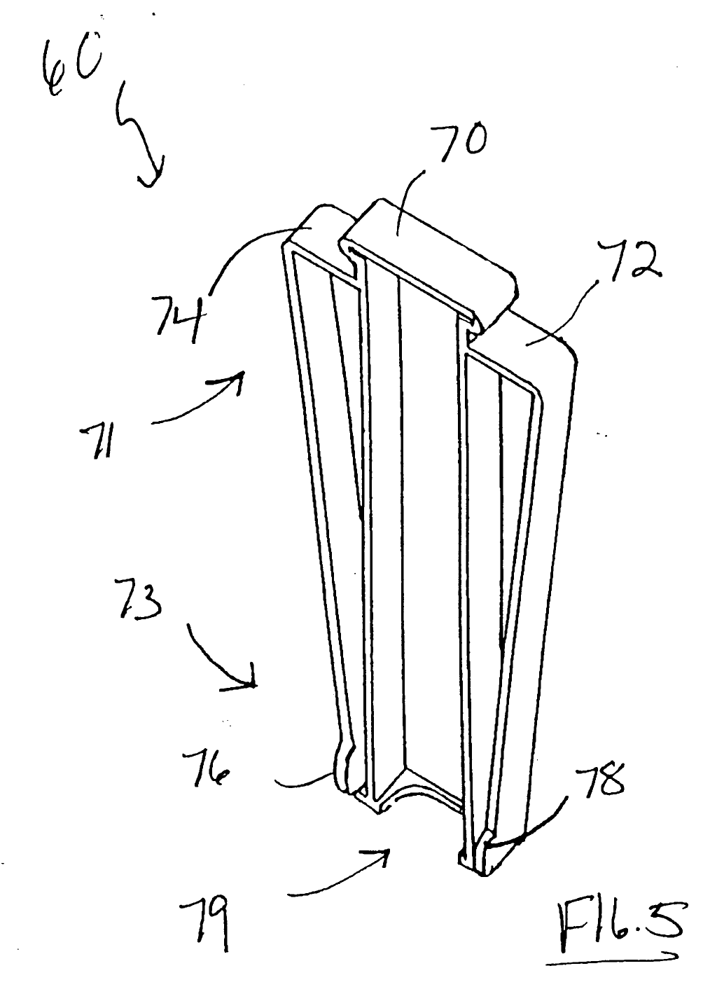

Turning to FIGS. 3-5, a first exemplary embodiment of the bracket according to the present invention is shown. Bracket 80 generally includes two components—mounting platform 50 and support leg 60. First, mounting platform 50 includes a planar top surface 58, which confronts the accessory item that the bracket supports when in an assembled state. Mounting platform 50 is generally rectangular in shape and includes a front end 82, back end 84, and a pair of side ends 86 extending therebetween. Back end 84 includes groove 81 for nestably receiving electrical cord 34, shown above in FIG. 2, which adds overall structural support to mounting platform 50.

Mounting platform 50 also includes a centrally located entryway 90 that extends through a majority of the width of mounting platform 50. Entryway 90 terminates in an end wall 61 and includes laterally extending flanges 62 and 64 on either side thereof. End wall 61 further includes groove 69 formed therethrough, which, like groove 81, also is sized and adapted to nestably receive electrical cord 34. Visually, entryway 90 divides mounting platform 50 into two identical sections, each having an aperture 66 formed therethrough, and a downwardly depending finger or tab 68.

Support leg 60 is an elongate piece having an upper portion 71 which includes head 70 and shoulders 72, 74. Opposite upper portion 71 is lower portion 73 which includes feet 76, 78 and hose channel 79. Support leg 60 generally tapers toward the lower portion 73 such that the width of upper portion, W₁, is generally greater than the width of lower portion W₂.

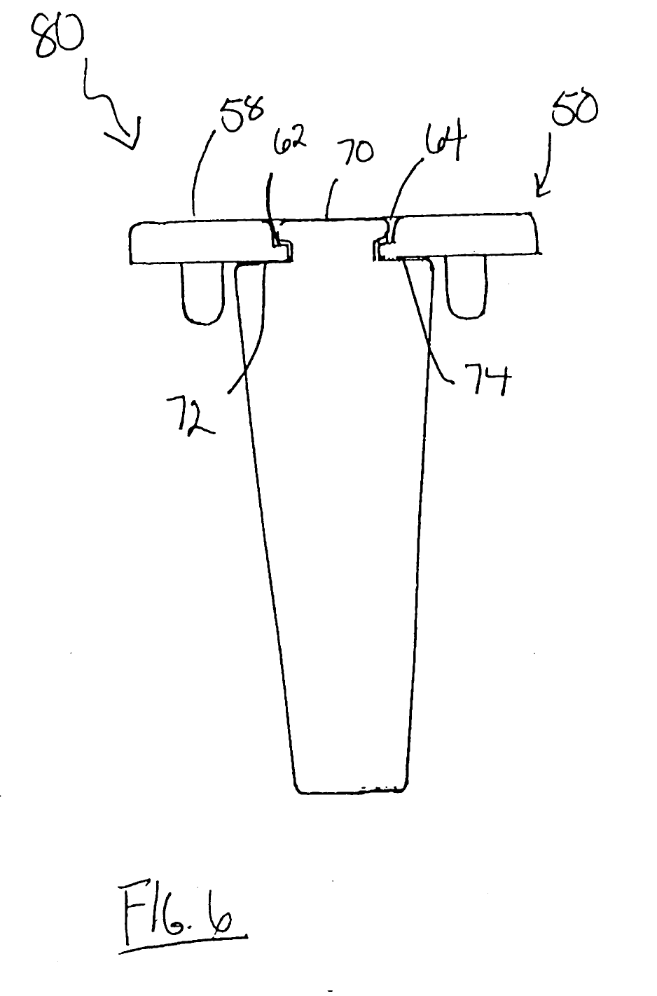

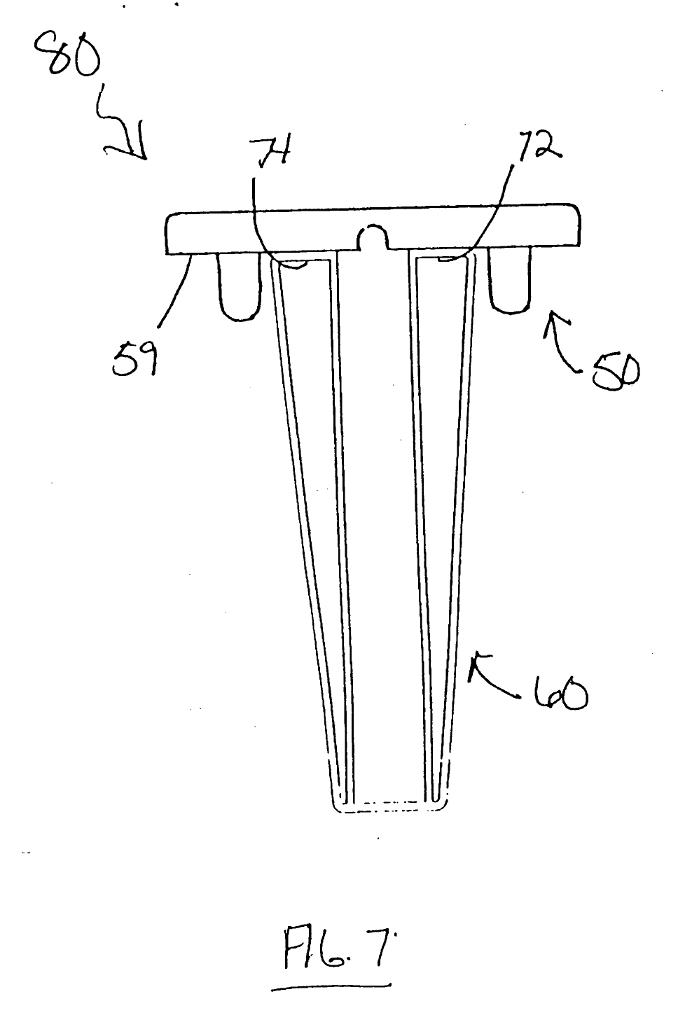

Mounting platform 50 slidably receives support leg 60. More particularly, head 70 is sized and adapted to be received by entryway 90 and travel the length of flanges 62 and 64, so that when the two components of bracket 80 are engaged, as shown in FIGS. 6 and 7, head 70 is flush with upper surface 58 of mounting platform, and shoulders 72 and 74 confront bottom surface 59 of mounting platform 50. In this way, movement of support leg 60 is confined to lateral movement along the length of the flanges. In other words, when the bracket components are engaged, support leg 60 is prevented from moving above upper surface 58 by the contact between shoulders 72 and 74 and lower surface 59. Similarly, support leg 60 is prevented from moving below lower surface 59 by the contact between head 70 and flanges 62 and 64.

Both mounting platform 50 and support leg 60 may each be formed of plastic, metal, wood, or other suitable material. Each piece and their respective features described above may be formed as an integral piece, such as by plastic injection molding.

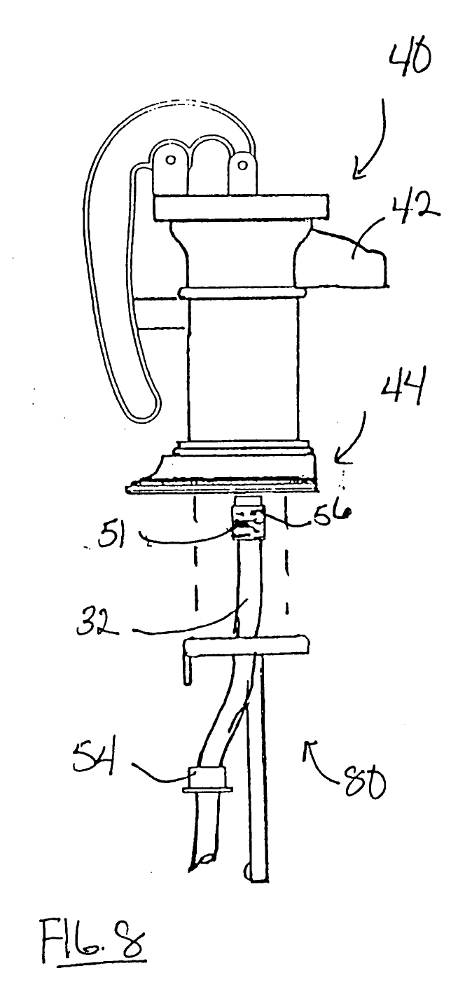

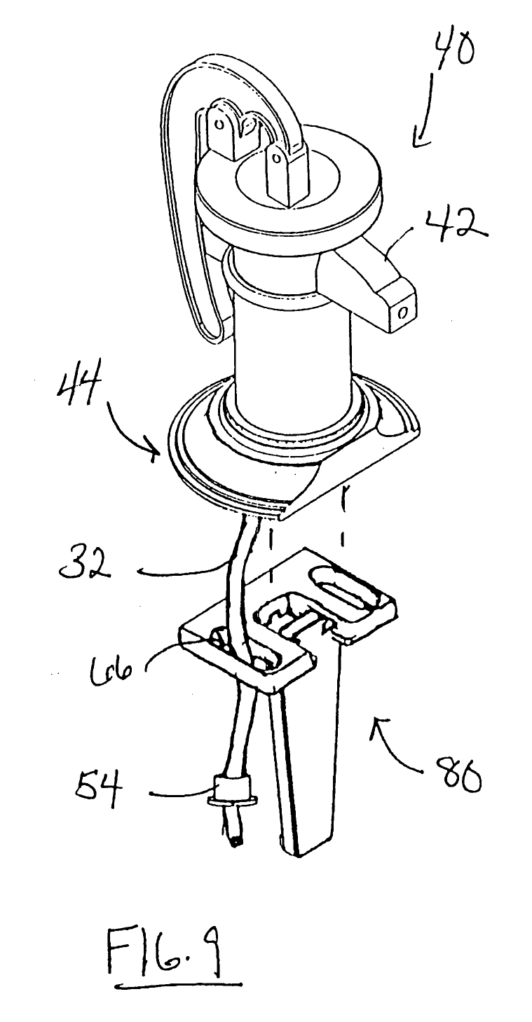

Now that the features of the bracket according to a first exemplary embodiment of the present invention have been described in some detail, the fastening of the bracket to the garden accessory, such as the spitter fountain shown in FIGS. 1 and 2, may now be described. Turning now to FIGS. 8 and 9, spitter fountain 40 has been provided with a mounting post in the form of threaded rod 56 projecting downwardly from base portion 44. An opening in base portion 44, which is concealed by rod 56, provides access into the interior of spitter fountain 40. Rod 56 is sized and adapted to receive hose 32 therein so that hose 32 is in fluid communication with the interior of spitter fountain 40 thereby to permit entry of water therein so that it may thereafter be dispensed via its spout 42.

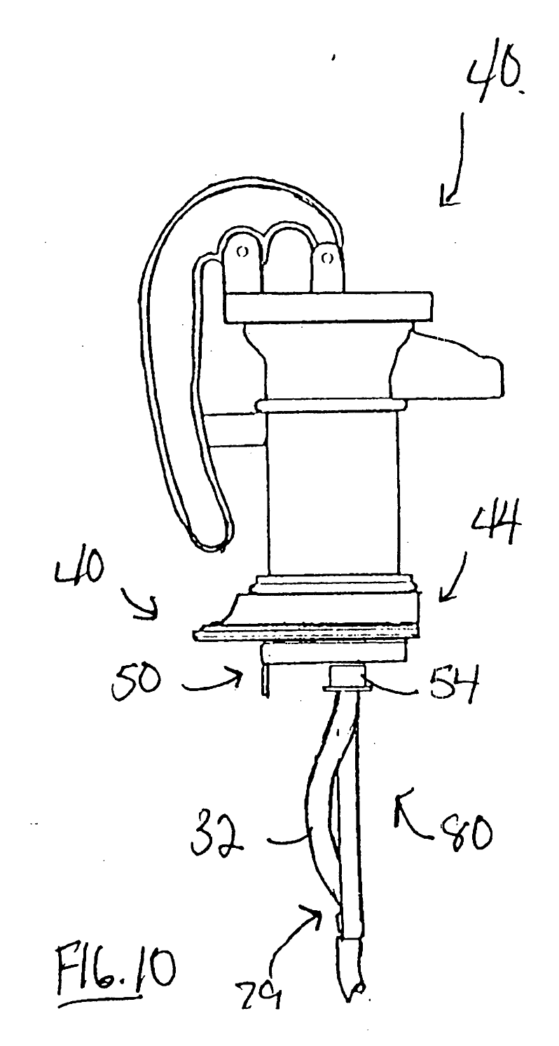

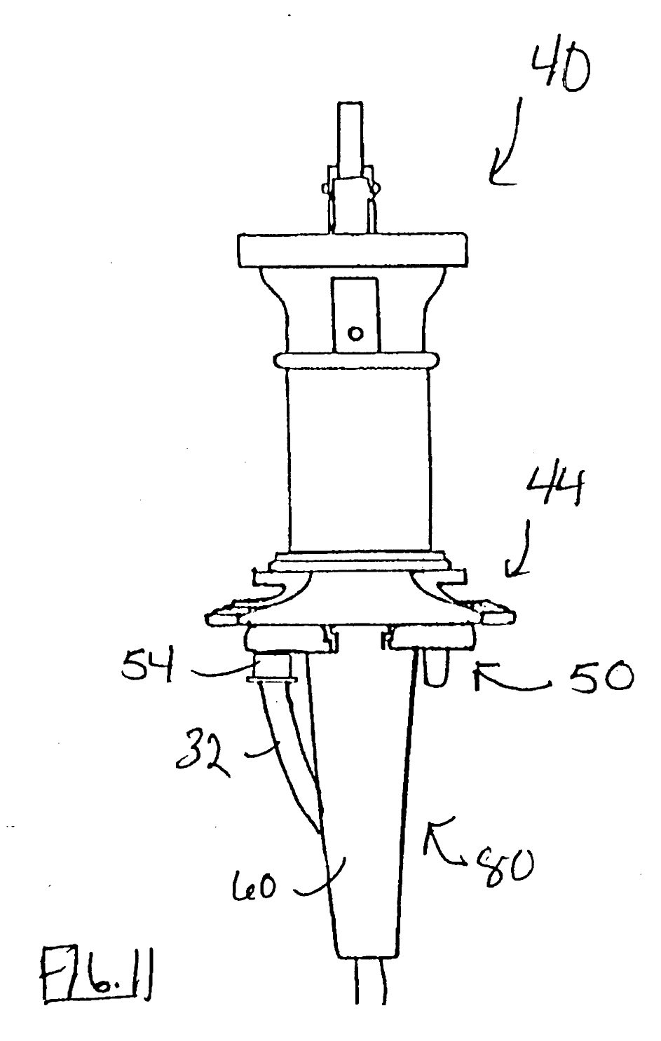

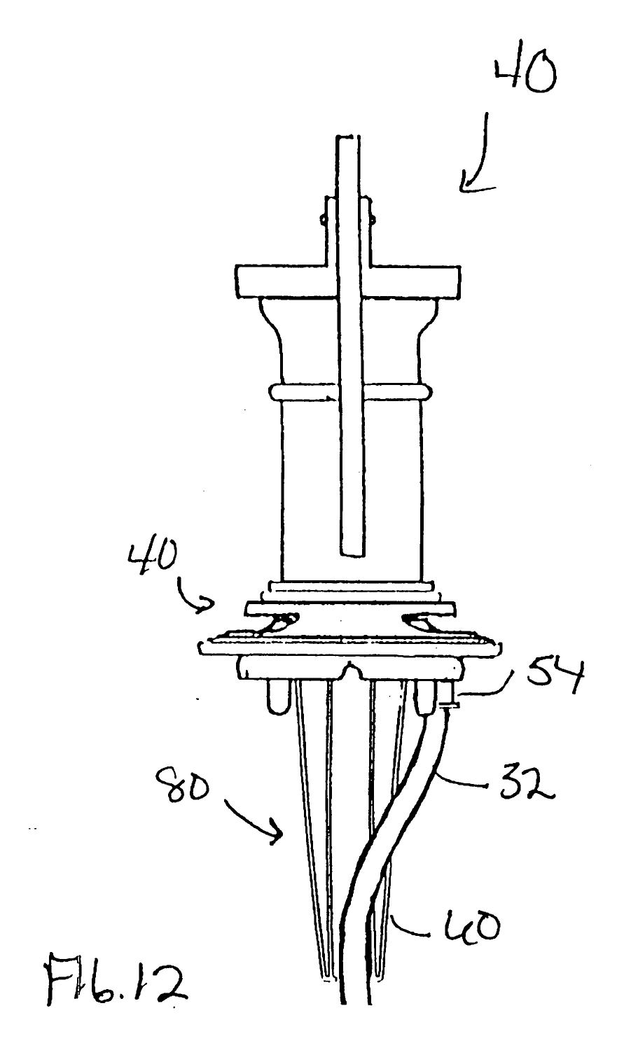

As shown, hose 32 is fed through a selected aperture 66 where it is next received by threaded nut 54. Threaded nut 54 is adapted to engage threaded rod 56 so as to be releasably secured thereto. Accordingly, as shown in FIGS. 10-12, when threaded nut 54 is secured to the threaded rod 56 on the spitter fountain, top surface 58 confronts base portion 44 of spitter fountain 40 such that spitter fountain 40 is seated on mounting platform 50 to define an assembled state. Hose 32 extends from threaded nut 54 along the length of support leg 60 where it then passes through hose channel 79. Additionally, as should be appreciated, electrical cord 34 may be laced up through hose channel 79 from pump 30 and then through grooves 69 and 81 and then over the sidewall of the vessel. Channel 79 and grooves 81, 69 help keep cord in place.

As perhaps best shown in FIGS. 10-13, mounting platform 50 need not extend under the entire area of the base portion of the accessory item that it supports. Rather, it is preferred that mounting platform 50 be concealed from view when the item is mounted thereon so as not to detract from the accessory item when placed in the garden.

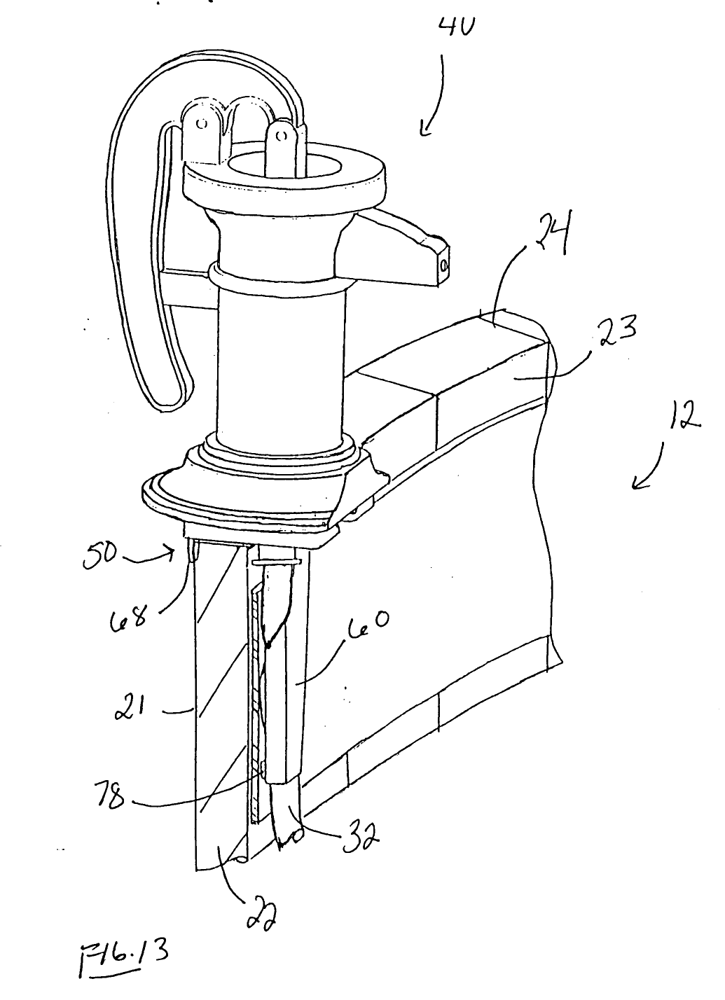

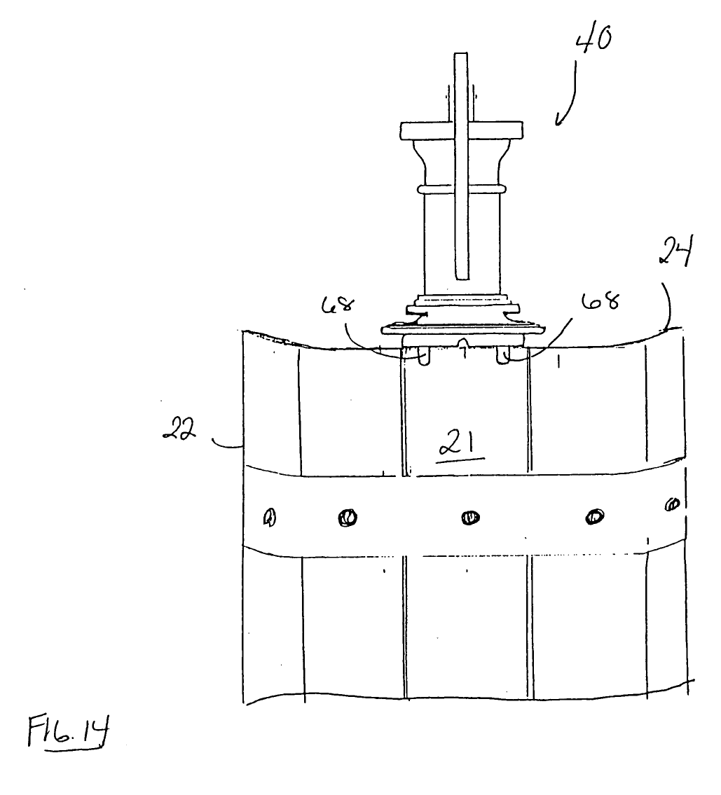

Turning now to FIGS. 13 and 14, the assembled bracket and spitter fountain is shown mounted to sidewall 22 of vessel 12. As shown, mounting platform 50 rests on top edge 24 of sidewall 22. Fingers 68 (one finger 68, partially in phantom, is shown in FIG. 13) of mounting platform 50 confront the outer surface 21 of sidewall 22. Support leg 60 has been pushed into the entryway of the mounting platform so that it confronts the interior surface 23 of sidewall 22 and liner 28. Foot 78 also rests against liner 28. Fingers 68 and support leg 60 work together to achieve the appropriate balance on top edge 24 such that mounting platform 50 appropriately bears the weight of spitter fountain 40.

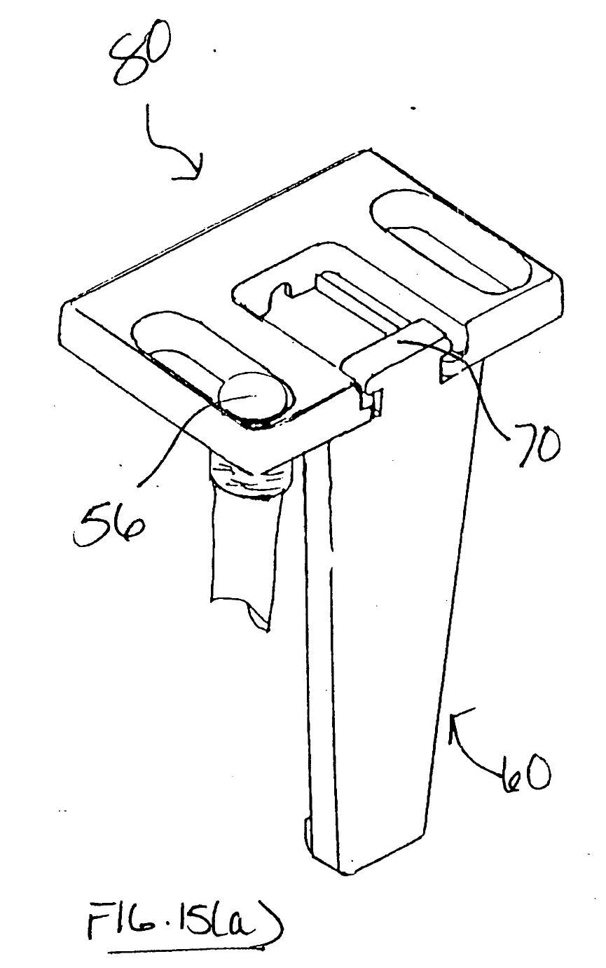

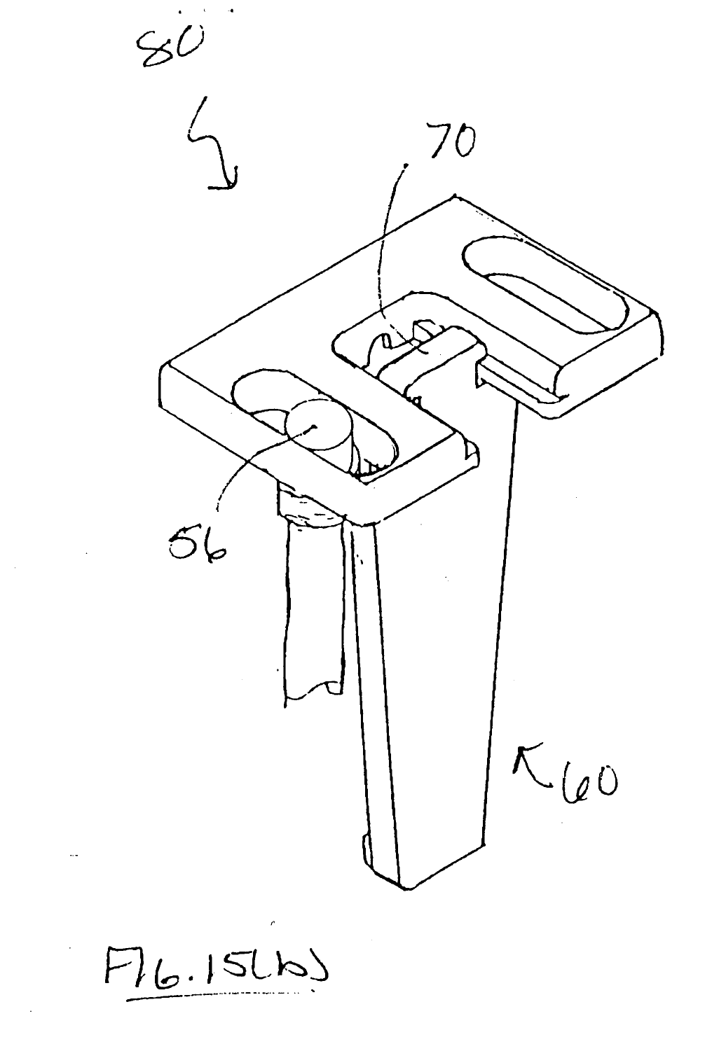

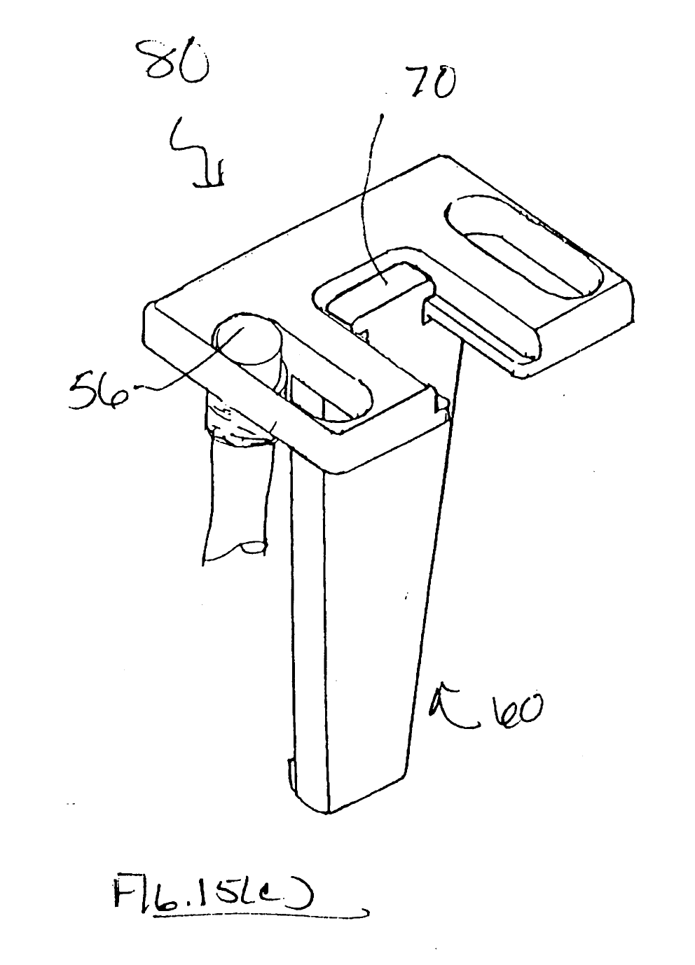

Some of the various bracket features heretofore described enable the bracket of the present invention to be adjustable to accommodate various vessels. For example, both the size and configuration of apertures 66 and entryway 90 formed in the mounting platform permit the selective positioning of the mounting post and the support leg. Three examples of this adjustability are shown in FIGS. 15(a)-15(c). When compared to one another, the position of mounting post 56 and head 70 of support leg 60 as shown in FIG. 15(a) are adjusted to mount bracket 80 to a sidewall having the largest width while the positioning of the same in FIG. 15(c) is adjusted for a sidewall that is comparatively less in width. The positioning of mounting post 56 and head 70, as shown in FIG. 15(b) is adjusted for a sidewall width somewhere in between that shown in FIGS. 15(a) and 15(b).

As should now be appreciated, it is not necessary that positioning rod 56 be necessarily parallel with head 70 of support leg 60. Rather, it is preferable that positioning rod 56 be located so that the water pump hose and the threaded nut do not interfere with the balance needed between the finger of the mounting platform and the support leg to mount the selected garden accessory item.

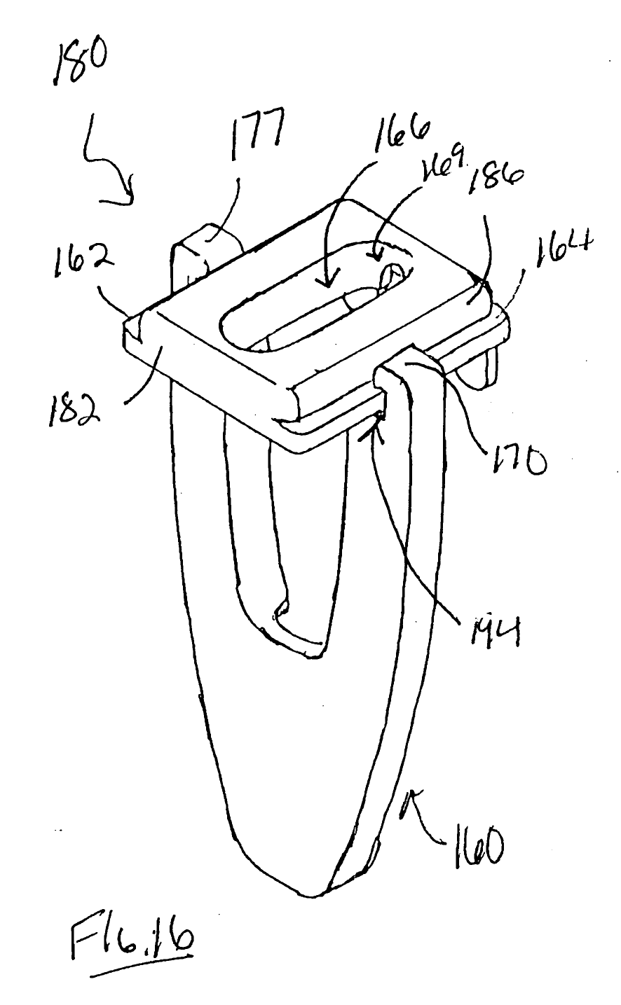

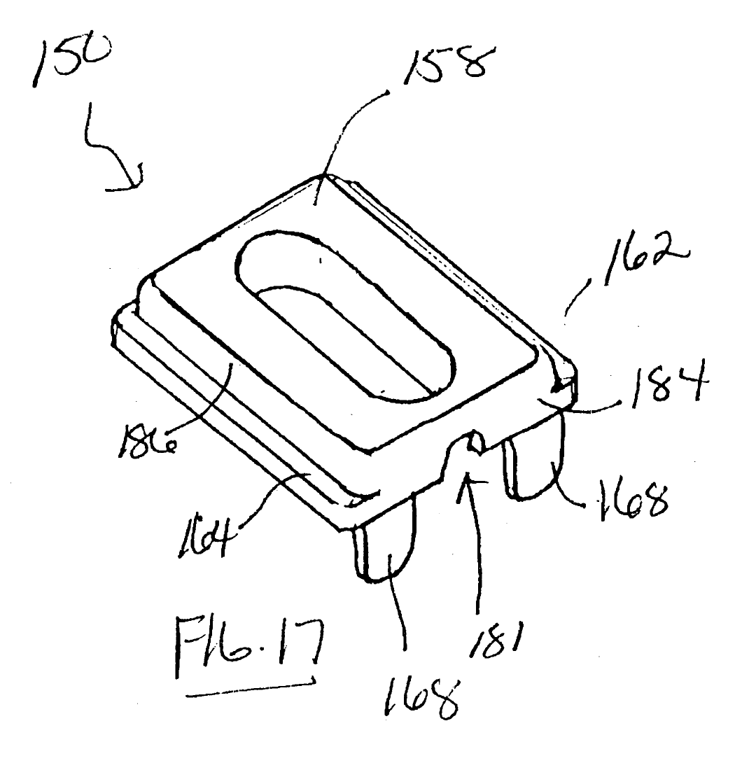

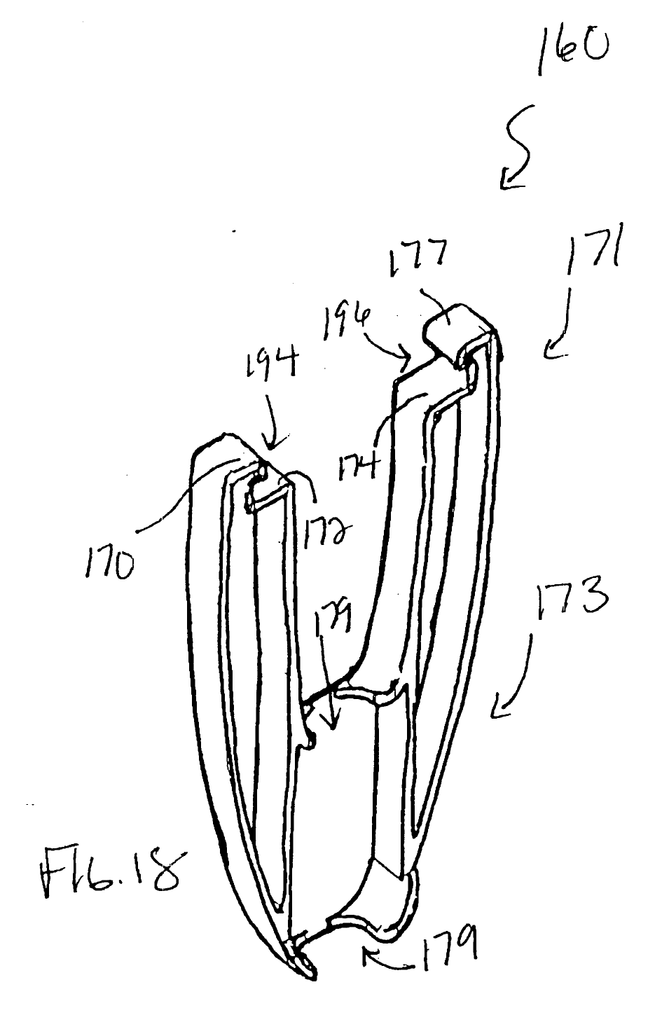

A bracket according to a second exemplary embodiment of the present invention is shown in FIGS. 16-18. Here, bracket 180 includes two components—mounting platform 150 and support leg 160 that is slidably received therein. Here, mounting platform 150 is a generally rectangular piece having a top surface 158, front wall 182, a back wall 184, and a pair of sidewalls 186 extending therebetween. Extending outwardly beyond sidewalls 186 are flanges 162 and 164. Mounting platform 150 also includes one centrally located aperture 166 formed therethrough and having groove 169, formed proximate to back wall 184. Back wall 184 also includes groove 181 formed therethrough. Together, grooves 169 and 181 receive and retain the electrical cord associated with the pump. Further, two downwardly depending fingers 168, which are proximate to back wall 184 and on either side of groove 181, are provided.

Support leg 160 is an elongate piece having an upper portion 171 and a lower portion 173. Upper portion 171 includes nubs 170 and 177 and shoulders 172 and 174, which form respective grooves 194 and 196. Support leg 160 generally tapers from upper portion 171 to lower portion 173 such that lower portion 173 has a smaller width than that of upper portion 171. Additionally, support leg 160 includes opening 192 and a pair of hose channels 179.

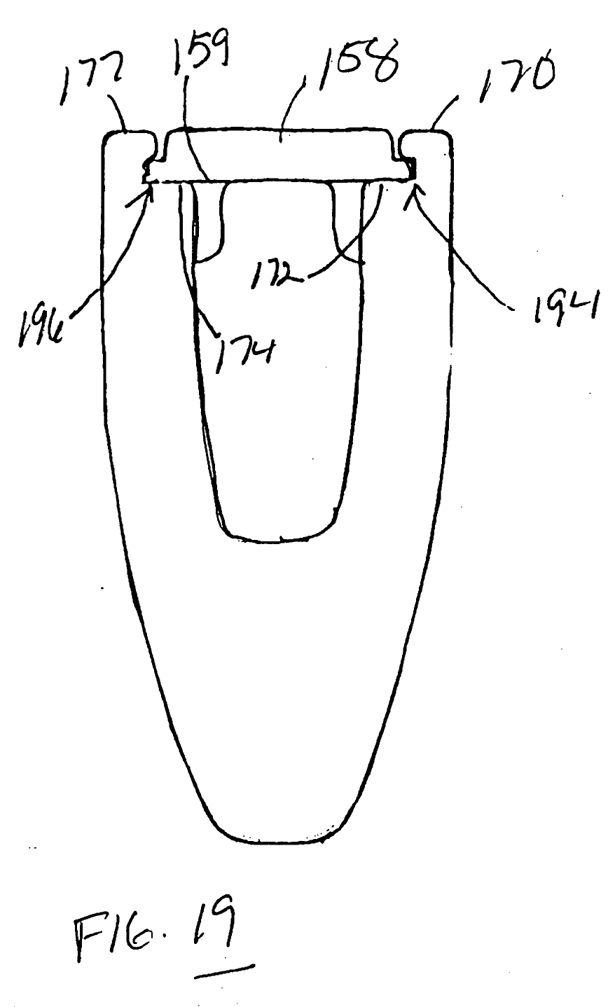

When mounting platform 150 and support leg 160 are assembled, as shown in FIGS. 16 and 19, flanges 162 and 164 on the mounting platform are received in the grooves 194 and 196 of the support leg and, once fitted thereon, the support leg is able to be selectively positioned along the length of the flanges. Once assembled, nubs 170 and 177 are flush with top surface 158 and shoulders 172 and 174 confront bottom surface 159 so as to confine movement of support leg 160 to travel along the length of the flanges. Additionally, when assembled, the electrical cord can be passed through hose channels 179 and up through grooves 169 and 181 so as to be received and retained thereby and to provide discreet passage up and over the vessel sidewall for insertion into the electrical outlet.

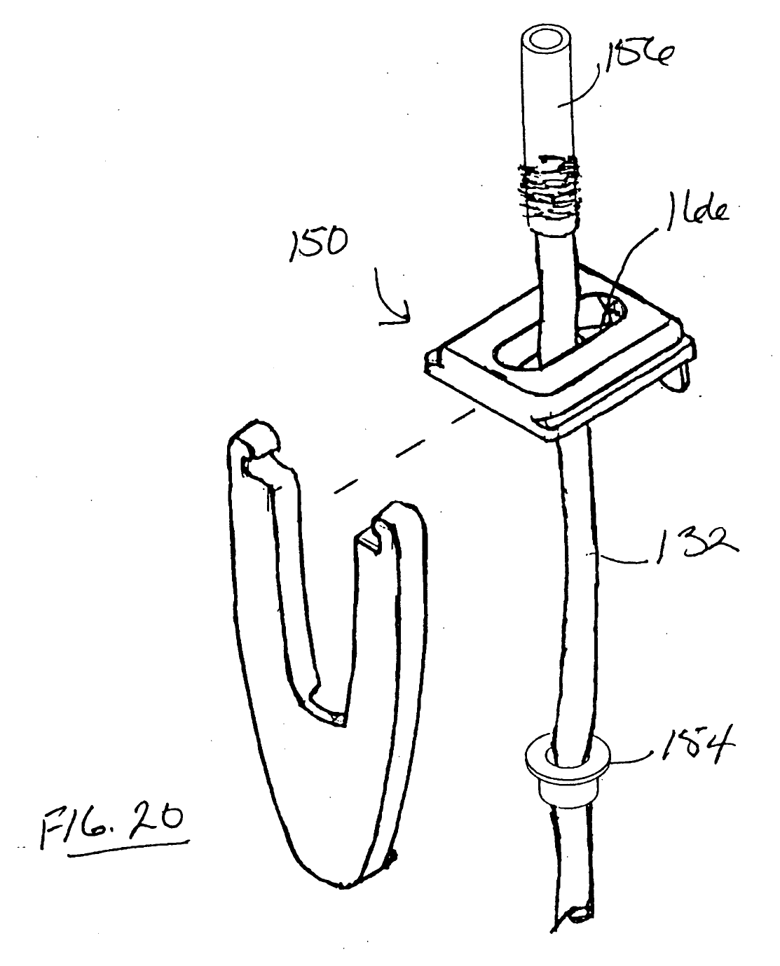

As shown in FIG. 20, hose 132 is fed through aperture 166 in mounting platform 150. Similar to that described above, threaded nut 154 is received by threaded mounting rod 156 thereby to assemble the selected accessory item to the bracket. As shown here, mounting rod 156 is not shown in connection with a spitter fountain, but it should be appreciated that any water accessory item that can be associated with such a mounting rod is contemplated for assembly onto the bracket of the present invention. Further, it should be appreciated that non-water garden accessory items can also be mounted, such as flower pots, or decorative outdoor items such as weather vanes, or even a fish food dispenser.

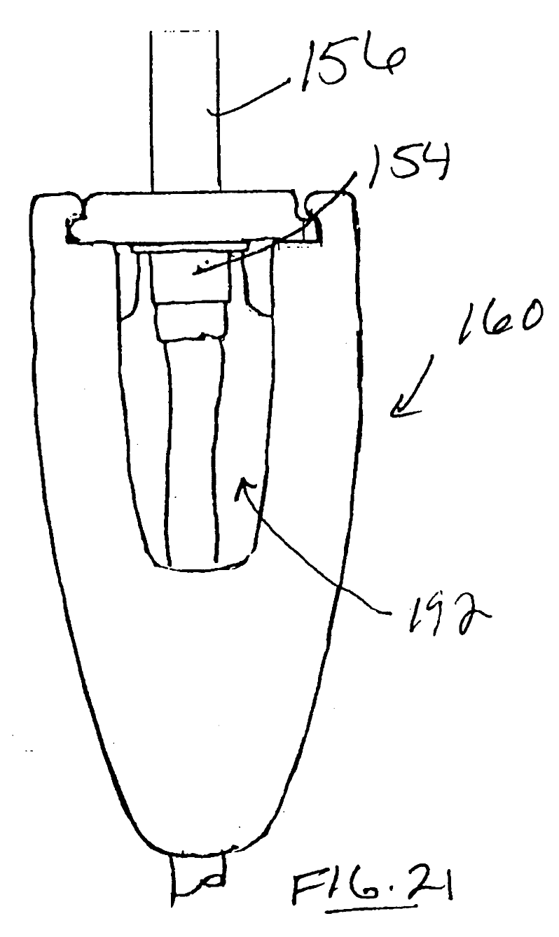

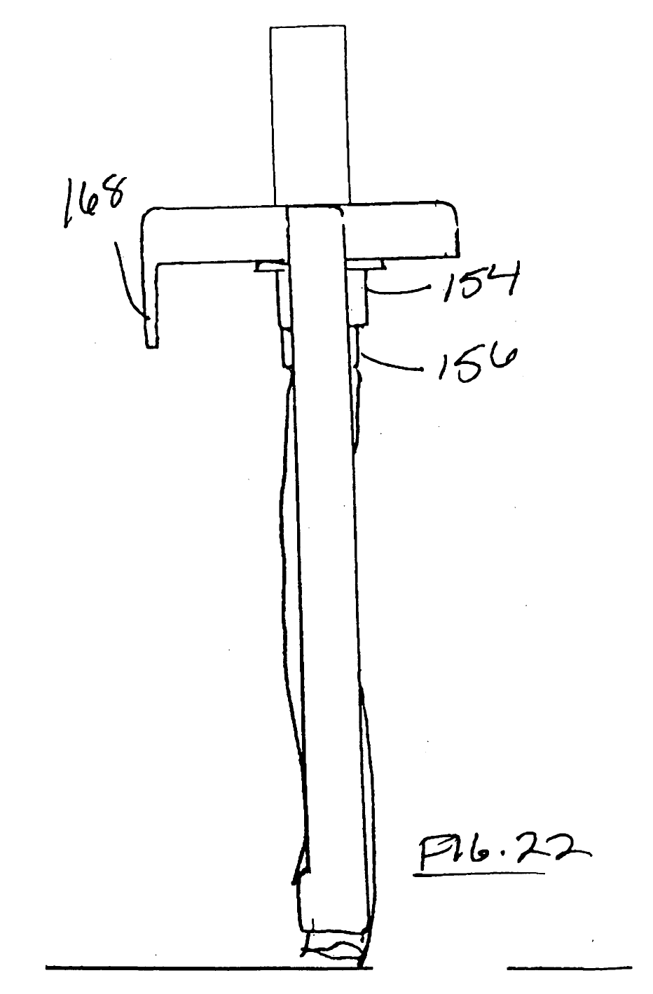

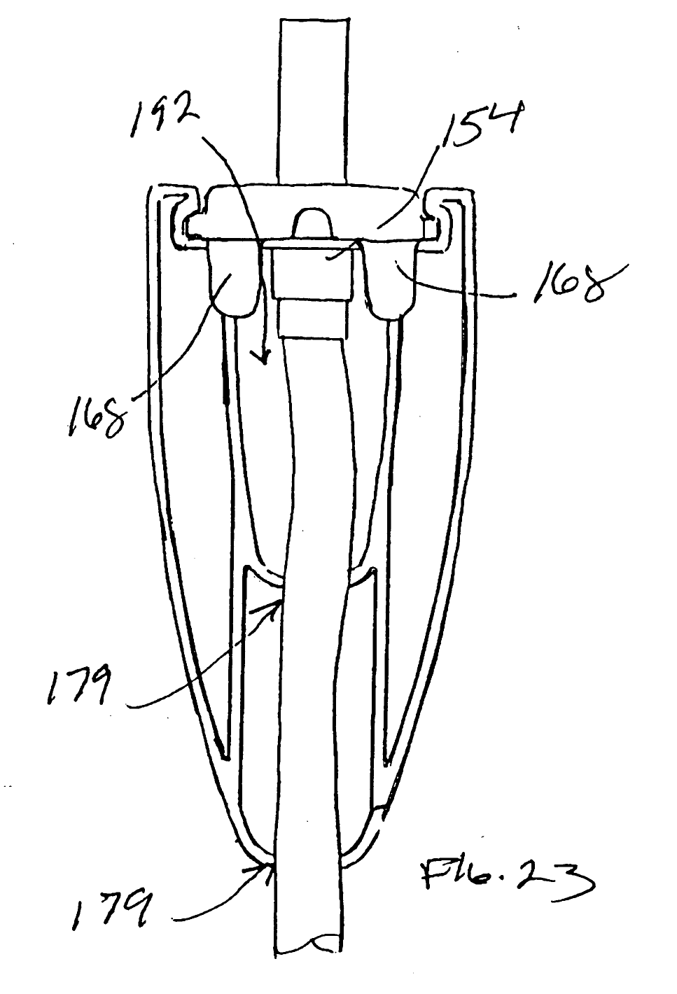

FIGS. 21-23 show bracket 180 in the assembled state, whereby threaded nut 154 is received by mounting rod 156 and secured to the underside thereof. Hose 132 is received by hose channels 179 to facilitate placement of the hose when mounted to the sidewall of the vessel. Further, as shown in the figures, opening 192 formed in support leg 160 accommodates both mounting rod 156 and threaded nut 154 therein to permit the versatility of the bracket to mount accessory items to vessel sidewalls of varying thicknesses. As should be appreciated, assembled bracket and accessory item may then be mounted to the sidewall of a water garden vessel in the manner discussed above with reference to FIGS. 13 and 14. Accordingly, fingers 168 and support leg 160 together stabilize the entire assembly when mounted on the sidewall.

The present invention further contemplates providing a kit. The kit would include a bracket according to the present invention, and may specifically include a bracket such as those described above. The kit may further include a liner, for lining a whisky barrel or other selected water vessel that needs to be water proofed. The kit may also include a spitter fountain or other water accessory item having a mounting post associated therewith for assembly with the bracket. Finally, the kit may also be provided with a conventional submersible recirculating water pump.

From the foregoing, it should be appreciated that the present invention is also directed to a method for supporting a selected garden accessory product to the sidewall of a vessel, or other appropriate support structure. The method includes providing a bracket having an aperture formed therein that is sized and adapted to receive a mounting post, such as a threaded rod. The method further includes the step of releasably securing the accessory item to the bracket, such as by fastening a threaded nut onto the mounting rod. Other suitable fasteners known in the art are also contemplated, such as snaps, ties and other matable fasteners. Once secured to the bracket, the method further includes adjusting the bracket to accommodate the width of the sidewall and then mounting the entire assembly onto the sidewall of the vessel. Further, it should be understood that this method includes any step contemplated by the structures described above.

Accordingly, the present invention has been described with some degree of particularity directed to the exemplary embodiments of the present invention, It should be appreciated, though, that the modifications or changes may be made to the exemplary embodiments of the present invention without departing from the inventive concepts contained herein.

What is claimed is:

1. An adjustable bracket for supporting and mounting an object on top of a generally planar sidewall of a support structure, comprising:
a mounting platform configured to be supported on an upper edge of said sidewall, said mounting platform providing a surface upon which the object can be seated; and
a support leg that frictionally cooperates with said mounting platform to maintain said mounting platform in position when supported on said upper edge and to enable said mounting platform to bear a weight of said object seated thereon, said support leg being adjustable with respect to said mounting platform to accommodate sidewalls of different widths.

2. The adjustable bracket as set forth in claim 1, wherein said mounting platform has at least one depending tab for engagement with one side of said sidewall adjacent said upper edge and said support leg engages an opposite side of said sidewall.

3. The adjustable bracket as set forth in claim 2, wherein said mounting platform is generally rectangular with a length and a width defining the object-seating surface and an opposing bottom surface that confronts said upper edge, each of said surfaces being generally planar and generally parallel to one another.

4. The adjustable bracket as set forth in claim 3, wherein said mounting platform includes a centrally located entryway that extends through a majority of said width, said entryway having laterally extending flanges on either side thereof and dividing said mounting platform into two substantially identical sections each having an aperture formed therethrough that extends from said object-seating surface to said bottom surface for variable seating of said object.

5. The adjustable bracket as set forth in claim 4, wherein said support leg includes an elongate member having an upper portion and a lower portion, said upper portion including a generally T-shaped head and two shoulders, said head sized to slide in said entryway and to travel a length of said flanges with an upper surface thereof being flush with said object-mounting surface, and said two shoulders confronting said bottom surface such that said support leg is limited to lateral movement along the length of said flanges.

6. The adjustable bracket as set forth in claim 1, wherein said mounting platform is made of a plastic material and is integrally molded to include a plurality of reinforcing ribs oriented generally perpendicularly to said object-seating surface.

7. A kit for creating a water garden using an open vessel suitable for holding water, comprising:
a water garden accessory item configured to operate as a spitter fountain;
a bracket for mounting said water garden accessory item on an upper edge of a generally planar sidewall of said open vessel, said bracket being adjustable to accommodate sidewalls of different widths; and
a water pump assembly for cooperating with said water garden accessory item to activate the spitter fountain.

8. The kit as set forth in claim 7, wherein said adjustable bracket includes:
a mounting platform having a generally planar upper surface upon which the water garden accessory is supported and a generally planar bottom surface that confronts the upper edge of the vessel sidewall; and
a support leg that cooperates with said mounting platform to maintain said mounting platform in position when supported on said upper edge and to enable said mounting platform to bear a weight of said water garden accessory supported thereon.

9. The kit as set forth in claim 8, wherein said mounting platform includes a generally rectangular member with a centrally located entryway that extends through a majority of a width of said member, said entryway having laterally extending flanges on either side thereof, said entryway dividing said mounting platform into two sections each having an elongated aperture formed therethrough and a downwardly depending tab extending from a side edge of said platform opposite said entryway.

10. The kit as set forth in claim 9, wherein said support leg includes an elongate member having an upper portion and a lower portion, said upper portion including a head and two shoulders, said head sized to be slidably received in said entryway and to travel a length of said flanges with an upper surface thereof being flush with said platform upper surface, and said two shoulders confronting said platform bottom surface such that said support leg is limited to lateral movement along the length of said flanges.

11. The kit as set forth in claim 10, wherein when said mounting platform and support leg are mounted on the vessel, said tabs abut an outer surface of said vessel and said support leg is moved inwardly along the length of the flanges until said leg comes into abutment with an inner surface of said vessel.

12. The kit as set forth in claim 9, wherein said water garden accessory includes a downwardly extending tubular projection on a bottom surface thereof having a water passageway that passes therethrough and exits at a spitter fountain spout, said projection sized to extend through either of said apertures and to be adjustable in position along a length thereof and then secured in position by a fastening element.

13. The kit as set forth in claim 12, wherein said water pump assembly includes a submersible recirculating water pump for placement in the vessel, an electrical cord for plugging the pump into an electric power outlet, and a water hose for connecting said pump to said water passageway in said tubular projection.

14. The kit as set forth in claim 13, wherein said mounting platform further includes a groove passing from a rear wall of said entryway to said side edge from which said tabs depend, said groove accommodating said electrical cord for discrete placement thereof in the water garden.

15. The kit as set forth in claim 7, further comprising a plug for sealing a hole in a planter that is to be used as the vessel.

16. The kit as set forth in claim 12, wherein said tubular projection is threaded and said fastening element is a nut that tightens against the bottom surface of the mounting platform.

17. A method for creating a water garden using an object suitable for holding water and having an open top, said method comprising:
positioning an object suitable for holding water and having an open top and a generally vertical sidewall for supporting a decorative water garden accessory item configured to operate as a spitter fountain, said accessory item having a downwardly projecting mounting post;
providing an adjustable bracket for mounting said water garden accessory item on an upper edge of said generally vertical sidewall, said bracket having an aperture formed therein that is sized and adapted to receive said mounting post;
passing said mounting post through said aperture and releasably securing said accessory item to said bracket with a fastening element; and
adjusting said bracket to accommodate a width of said sidewall and mounting said bracket with the attached accessory item to said sidewall.

18. The method as set forth in claim 17, wherein said bracket includes a support leg and a mounting platform having a downwardly depending tab, said step of adjusting including placing said tab against an outer surface of said sidewall and sliding said support leg along laterally arranged flanges on said mounting platform to bring said support leg into engagement with an inner surface of said sidewall while frictionally engaging said flanges.

19. The method as set forth in claim 17, wherein said step of passing said mounting post through said aperture includes rotatably adjusting said accessory item around said mounting post to a desired orientation and securing said accessory item in said orientation with said fastening element.
